(19) United States
(12) Patent Application Publication
(10) Pub. No.: US 2004/0015867 A1
(43) Pub. Date: Jan. 22, 2004

(54) Automated usability testing system and method

(76) Inventors: John Steven Travis Macko, Gloucester (CA); Scott McEwen, Ottawa (CA)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/385,972

(22) Filed: Mar. 11, 2003

(30) Foreign Application Priority Data
Jul. 16, 2002 (CA) 2,393,902

(51) Int. Cl. G06F 9/44; G09G 5/00

(52) U.S. Cl. 717/125; 345/789

(57) ABSTRACT

The present invention relates to an automated usability testing system and method. The system includes a test plan creator for constructing a test plan, a data logger for collecting test data in a data log guided by the constructed test plan, a log analyzer for automatically summarizing the data log in a summary report, and a test database for storing test and participant information. The method includes the steps of constructing a test plan, conducting a test guided by the constructed test plan, collecting test data, automatically summarizing the collected test data, and storing test and participant information.

### FIELD OF THE INVENTION

The present invention relates generally to software development, and more particularly to usability testing of user interfaces.

### BACKGROUND OF THE INVENTION

Within the software development process, user input has become an essential component in the design of the user interface. In order to collect this input, a process known as usability testing has been developed to verify the usability of software designs. Usability testing is an extension of practices begun in the late 1980s that included basic principles of user centered design, research methodology, and psychological/cognitive behavioral studies. These basic principles have continued to be refined and extended within the usability testing environment to evaluate software products with respect to human performance, ease of use, and user satisfaction.

Early usability tests were typically conducted on a product just prior to its beta release, with observations being recorded on paper checklists. They typically included large numbers of participants, and were often conducted from start to finish within several weeks. Gradually over time, a heightened awareness has developed regarding the important role usability testing plays in product development. This has resulted in an increased demand for usability testing involving more complex tests.

Today, usability testing is entering the product lifecycle earlier and earlier, often starting at the requirements stage. Further, with software product development timelines becoming shorter and shorter, development teams now require rapid usability test results and recommendations. The problem is that existing usability testing methods and systems are inadequate for today's fast-paced development environment, and are often restricted to a single stage of the usability testing process. In addition, the dedicated software typically bundled with these systems works only with their hardware, and without a comprehensive approach to the overall usability testing process.

With the advent of this fast-paced development environment, what is needed is a similarly fast paced system and method for conducting usability tests. Further, it would be advantageous to provide an end-to-end system and method for conducting usability tests that facilitates the overall process of planning, recruiting, conducting, analyzing, and reporting. usability tests in an automated and expedited manner.

For the foregoing reasons, there is a need for an improved system and method for usability testing.

### SUMMARY OF THE INVENTION

The present invention is directed to an automated usability testing system and method. The system includes a test plan creator for constructing a test plan, a data logger for collecting test data in a data log guided by the constructed test plan, a log analyzer for automatically summarizing the data log in a summary report, and a test database for storing test and participant information.

In an aspect of the present invention, the system further includes a participant manager for managing participant information. In an aspect of the present invention, the participant manager includes means for automatically emailing invitations to one or more potential participants. In an aspect of the present invention, the system further includes means for creating test supporting materials such as task lists, rating scales, and test sponsor versions of the test plan. In an aspect of the present invention, the test database includes means for continuously summarizing usability testing output such as the number of tests by month, product, or facilitator, severity and number of issues discovered.

The method includes the steps of constructing a test plan, conducting a test guided by the constructed test plan, collecting test data, automatically summarizing collected test data, and storing test and participant information.

In an aspect of the present invention, the method further includes the step of managing participant information. In an aspect of the present invention, the participant information management step includes the step of automatically emailing invitations to one or more potential participants. In an aspect of the present invention, the method further includes the step of creating supporting materials such as task lists, rating scales, and test sponsor versions of the test plan. In an aspect of the present invention, the method further includes the step of continuously summarizing usability testing output such as the number of tests by month, product, or facilitator, severity and number of issues discovered.

The invention provides the structure for a consistent and repeatable process and standardized reporting, making it easier for new test facilitators to learn and use the system. Furthermore, the invention enables faster turn-around of testing that provides a quick yet powerful end-to-end usability testing solution in an automated and error-reducing manner.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of an automated usability testing system according to an embodiment of the present invention;

FIG. 2 is an overview of an automated usability testing method according to an embodiment of the present invention; and

FIG. 3 illustrates the system further including a participant manager according to an embodiment of the present invention.

### DETAILED DESCRIPTION OF THE PRESENTLY PREFERRED EMBODIMENT

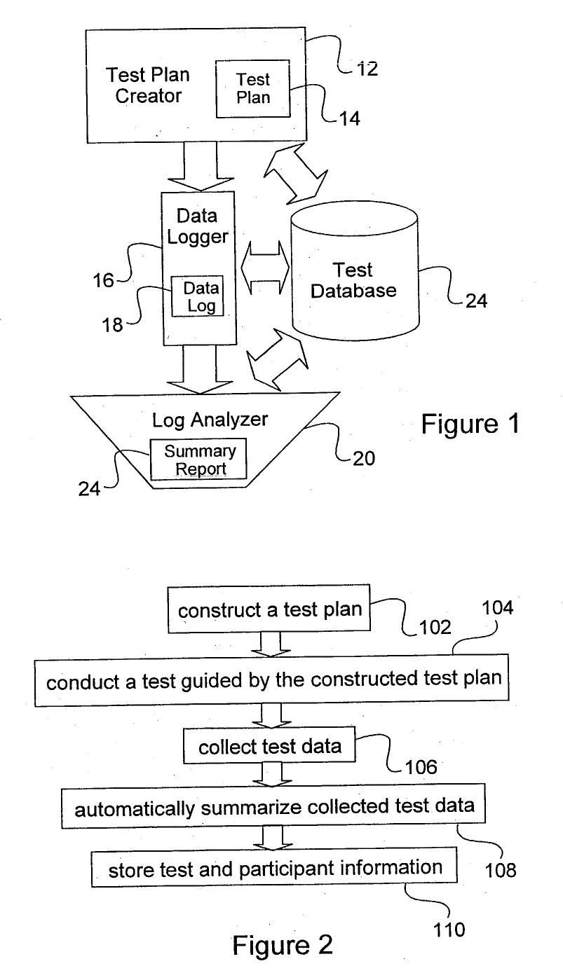

The present invention is directed to an automated usability testing system and method. As illustrated in FIG. 1, the system includes a test plan creator 12 for constructing a test plan 14, a data logger 16 for collecting test data in a data log 18 guided by the constructed test plan 14, a log analyzer 20 for automatically summarizing the data log 18 in a summary report 22, and a test database 24 for storing test and participant information.

As illustrated in FIG. 2, the method includes the steps of constructing a test plan 102, conducting a test guided by the constructed test plan 104, collecting test data 106, automatically summarizing the collected test data 108, and storing test and participant information 110.

The test plan creator 12 enables a test facilitator to construct a usability test plan 14 incorporating a specific syntax in the form of tags that can be imported and interpreted by the data logger 16. The test plan creator 12 provides the structure for a test plan 14, such as tasks and all related metrics that can be collected, including rating scales, open ended questions, demographics and preferences. A subset of usability metrics is chosen for each test from a list of proven core metrics, depending upon the questions from which the sponsor requires an answer.

The test plan creator 12 supports single design and multiple design usability tests with counterbalancing. The test plan creator 12 assigns the appropriate tags that are interpreted by the data logger 16 and presented as tasks and events in serial order. In addition, in an embodiment of the present invention, the test plan creator 12 has the ability to create supporting materials for the participant such as task lists, rating scales, and a simplified version of the test plan for the test sponsor.

Typically, the data logger 16 is installed on a laptop computer and operated with the keyboard only. The test facilitator can simultaneously operate the test and log the participant's performance, precluding the need for an additional facilitator to collect data. Since the data logger 16 records the testing data, the invention enables a test facilitator to track multiple tasks and multiple designs, unobtrusively time each task, and automatically summarize “Able to Do” metrics based on the number of hints provided. The data logger 16 easily logs core metrics through the use of buttons and keyboard shortcuts.

In addition, the data logger 16 automatically exports the test results into two separate spreadsheet files. The first spreadsheet file contains the recorded metrics for each participant. The second spreadsheet file contains a summary of the raw data across all participants. The log analyzer 20 creates a summary report 22 by sorting the data log 18 by task, then by design if more than one prototype is tested, and then by event. After the sort, all Task 1 data is grouped together, all Task 2 data is grouped together, and so-on across all participants. This format facilitates the identification and description of usability issues for each task. Important data and events can then be cut from the spreadsheet and pasted into sections of a report as required.

Upon completion of the test, the log analyzer 20 reads the log file 18 created by the data logger 16 and performs a summary analysis, replacing the traditional method of manual data analysis that is inherently time consuming and error prone. The log analyzer 20 performs data summarization by task and event, and an analysis of metrics. The summarized data is then included as an appendix in a usability test report. The summary report 22 can be communicated to development teams immediately, precluding the need to wait several days for a full report. Final reports are written by the test facilitator using a template and based on the summary report 22.

The test database 24 can export test statistics to a spreadsheet for summarization and/or cost-justification to management, such as the number of tests per period or product, and the total number of usability issues discovered. In an embodiment of the present invention, the test database 24 continuously summarizing descriptive statistics for usability testing, such as number of tests, date, facilitator, severity and number of issues discovered, number of participants tested, participant expertise, and task details.

As illustrated in Table 1, the end-to-end testing process in a typical test follows a six-day cycle. To save time and promote consistency, templates are used for supporting materials and final reports. The templates add value to the process due to the ability to easily cut and paste existing standardized items into new documents. As well, when new or more efficient procedures are discovered, the templates can be easily updated.

TABLE 1
Example Usability Testing Time-Line

| Day | Process |
|---|---|
| 1 | Obtain user analysis, task list, product/prototype demo from the |
| | sponsor (UI designer/product development team) |
| | Install prototype/product on test machine |
| | Become familiar with product/prototype through usage |
| | Begin writing test plan |
| 2 | Review test plan with sponsor and achieve sign-off |
| | Create supporting test materials (for example, the participant's |
| | task list) |
| | Recruit participants |
| 3 | Conduct the usability test |
| | Revise the log files |
| 4 | Conduct the usability test |
| | Revise the log files |
| | Prepare the initial summary report |
| 5 | Prepare redesign recommendations |
| 6 | Finish draft of report |
| | Submit report to sponsor and discuss results |
| | Finalize report |

Test requirements are obtained from a test sponsor, including desired participant profile, preliminary task list, hardware requirements, demonstration of the prototype, and confirmation of testing dates. A typical test takes about 30-45 minutes, evaluates seven to nine tasks, and requires six to eight participants. Each test is documented in four files: the test plan 14, the supporting materials that the participants are given, an initial summary report 22, and a final report.

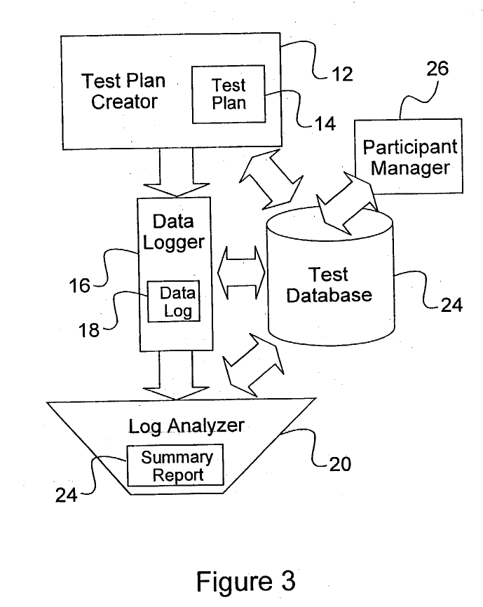

As illustrated in FIG. 3, in an embodiment of the present invention, a participant manager 26 is further included for facilitating the recruiting of participants, adding or updating. Recruiting participants, traditionally an unpleasant and time-consuming process, is now made more pleasant and efficient. The participant manager 26 enables a test administrator to select potential participants from the test database 24, and filter the selected participants according to certain desired characteristics, such as expertise with a specific product, office location, and/or date of last test participation.

The participant manager 26 is used to recruit test participants. Using profile information, participants are selected based on specific required characteristics for the given test. A filtering mechanism enables the selection of precise participant profiles such as product expertise, or location. The test database 24 includes an email function that sends a standardized invitation to participate to one or more potential participants. Recruiting participants, once a time-consuming process, is now made more efficient.

The participant manager 26 facilitates the addition of new participants and the modification of existing ones, and tracks the tests that each participant has completed. In conducting a test, the test facilitator uses the data logger 16 to read and follow the test plan 14 imported from the test plan creator 12. The data logger 16 provides an ability to display and navigate through the test plan 14, and record specific user interactions. The data logger 16 presents the test plan tasks to the test administrator, who then relates them to the test participant. Events such as rating scales, questions, and preferences are automatically presented in correct sequence, so that information is easily and properly collected. Comments and reactions from the participants can also be recorded. The data logger 16 controls RECORD and STOP VCR events, and writes time-stamped data to the data log 18 as well.

The participant manager 26 facilitates the addition of new participants and the modification of existing ones, and has the ability to send potential participants a personalized e-mail invitation. The participant manager 26 can track the tests that each participant has completed, and can export test statistics to a spreadsheet for summarization and/or cost-justification to management, such as the number of tests per year or total usability issues discovered.

The participant manager 26 is used to update participant and test information, and includes information about potential test participants such as name, job title, and product expertise, since it is desirable that appropriate individuals are selected for specific usability tests, such as novice versus experienced users.

Using the participant manager 26, a test facilitator can reach a wider spectrum of potential testing participants by leveraging the widespread use of the Internet and the proliferation of corporate Intranets. This speeds up the process and reduces possible disincentives to participation. As well, the invention is well suited to an iterative design process since a test can be conducted every week, and iterated for as long as required. The invention empowers the test facilitator at every step of the process to enable quick test construction and turnaround times for test results, with each step easily adapted to a variety of testing situations.

The invention presents testing tasks in proper sequence and collects specific data at appropriate times, such as rating scales. In addition, the invention reduces errors such as omissions or tasks out of sequence, as well as errors in data analysis in both the creation of test plans 14, and the running of tests. The invention simplifies complex testing scenarios, typically up to four designs, in a counterbalanced manner, and provides the structure for a consistent process and standardized reporting. Furthermore, the invention is easier for new test facilitators such as new hires to learn and use, providing a quick, repeatable, and powerful end-to-end usability testing solution in an automated and error-reducing manner.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. An automated usability testing system comprising:
a test plan creator for constructing a test plan;
a data logger for collecting test data in a data log guided by the constructed test plan;
a log analyzer for automatically summarizing the data log in a summary report; and
a test database for storing test and participant information.

2. The system according to claim 1, further including a participant manager for managing participant information.

3. The system according to claim 2, wherein the participant manager includes means for automatically emailing invitations to one or more potential participants.

4. The system according to claim 1, further including means for creating test supporting materials such as task lists, rating scales, and test sponsor versions of the test plan.

5. The system according to claim 1, wherein the test database includes means for continuously summarizing usability testing output such as the number of tests by month, product, or facilitator, severity and number of issues discovered.

6. An automated usability testing method comprising the steps of:
constructing a test plan;
conducting a test guided by the constructed test plan;
collecting test data;
automatically summarizing the collected test data; and
storing test and participant information.

7. The method according to claim 6, further including the step of managing participant information.

8. The method according to claim 7, wherein the participant information management step includes the step of automatically emailing invitations to one or more potential participants.

9. The method according to claim 6, further including the step of creating supporting materials such as task lists, rating scales, and test sponsor versions of the test plan.

10. The method according to claim 6, further including the step of continuously summarizing usability testing output such as the number of tests by month, product, or facilitator, severity and number of issues discovered.

11. An automated usability testing system comprising:
means for constructing a test plan;
means for conducting a test guided by the constructed test plan;
means for collecting test data;
means for automatically summarizing the collected test data; and
means for storing test and participant information.

12. The system according to claim 11, further including means for managing participant information.

13. The system according to claim 12, wherein the participant information management means includes means for automatically emailing invitations to one or more potential participants.

14. The system according to claim 11, further including means for creating supporting materials such as task lists, rating scales, and test sponsor versions of the test plan.

15. The system according to claim 11, further including means for continuously summarizing usability testing output such as the number of tests by month, product, or facilitator, severity and number of issues discovered.

16. A storage medium readable by a computer, the medium encoding a computer process to provide an automated usability testing method, the computer process comprising:
a processing portion for constructing a test plan;
a processing portion for conducting a test guided by the constructed test plan;
a processing portion for collecting test data;
a processing portion for automatically summarizing the collected test data; and
a processing portion for storing test and participant information.

17. The method according to claim 16, further including a processing portion for managing participant information.

18. The method according to claim 17, wherein the participant information management processing portion includes a processing portion for automatically emailing invitations to one or more potential participants.

19. The method according to claim 16, further including a processing portion for creating supporting materials such as task lists, rating scales, and test sponsor versions of the test plan.

20. The method according to claim 16, further including a processing portion for continuously summarizing usability testing output such as the number of tests by month, product, or facilitator, severity and number of issues discovered.
